(19) United States
(12) Patent Application Publication
(10) Pub. No.: US 2013/0287288 A1
(43) Pub. Date: Oct. 31, 2013

(54) METHOD AND DEVICE FOR DETERMINING THE OFFSET DISTANCE BETWEEN TWO SURFACES

(71) Applicant: Clark Alexander Bendall, Syracuse, NY (US)

(72) Inventor: Clark Alexander Bendall, Syracuse, NY (US)

(73) Assignee: General Electric Company, Schenectady, NY (US)

(21) Appl. No.: 13/455,778

(22) Filed: Apr. 25, 2012

(51) Int. Cl. G06K 9/00

(52) U.S. Cl. 382/154

(57) ABSTRACT

A method and device for determining the offset distance between a first surface and a second surface is disclosed. The method and device determine a first reference surface, which is based on the three-dimensional coordinates of the first surface, and a second reference surface, which is based on the three-dimensional coordinates of the second surface. The offset distance is determined as the distance between a first point on the first reference surface and a second point on the second reference surface.

### BACKGROUND OF THE INVENTION

The subject matter disclosed herein relates to a method and device for determining the offset distance between two surfaces.

Video inspection devices, such as video endoscopes or borescopes, can be used to inspect a surface of an object to identify and analyze anomalies on the object that may have resulted from damage, wear, corrosion, or improper installation. In many instances, the surface of the object is inaccessible and cannot be viewed without the use of the video inspection device. For example, in many welding applications, two objects (e.g., pipes) are aligned and then welded together. Proper alignment of the pipes is important to avoid turbulence, wear, and potentially premature failure of the pipes and the weld. Accordingly, it is necessary to determine the offset distance, if any, between the inner surfaces of the pipes. Since pipe thicknesses are not uniform, even if the outer surfaces of the two pipes are perfectly aligned with no offset distance between the outer surfaces, that does not guarantee that the inner surfaces of the pipes are also perfectly aligned. A video endoscope can be used to inspect the inner surfaces of two pipes welded together to try to determine the offset distance between the inner surface of the first pipe and the inner surface of the second pipe adjacent to the weld. Conventional measurement techniques, however, do not provide sufficient precision in determining the offset distance.

The discussion above is merely provided for general background information and is not intended to be used as an aid in determining the scope of the claimed subject matter.

### BRIEF DESCRIPTION OF THE INVENTION

A method and device for determining the offset distance between a first surface and a second surface is disclosed. The method and device determine a first reference surface, which is based on the three-dimensional coordinates of the first surface, and a second reference surface, which is based on the three-dimensional coordinates of the second surface. The offset distance is determined as the distance between a first point on the first reference surface and a second point on the second reference surface. An advantage that may be realized in the practice of some disclosed embodiments of the method is the accurate determination of offset distances between the inner surfaces of pipes.

In one embodiment, a method for determining the offset distance between a first surface and a second surface is disclosed. The method comprises the steps of obtaining and displaying at least one image of the first surface and the second surface, determining the three-dimensional coordinates of at least three surface points on the first surface, determining the three-dimensional coordinates of at least three surface points on the second surface, determining a first reference surface based on the three-dimensional coordinates of the at least three surface points on the first surface, determining a second reference surface based on the three-dimensional coordinates of the at least three surface points on the second surface, determining a first point on the first reference surface, determining a second point on the second reference surface, and determining the offset distance between the first point and the second point.

In another embodiment, the method comprises the steps of obtaining and displaying at least one image of the first surface and the second surface, determining the three-dimensional coordinates of at least three surface points on the first surface, determining the three-dimensional coordinates of at least three surface points on the second surface, determining a first reference surface based on the three-dimensional coordinates of the at least three surface points on the first surface, determining a second reference surface based on the three-dimensional coordinates of the at least three surface points on the second surface, determining an offset measurement surface point on the at least one image, determining a first point on the first reference surface by determining the point where a first line extending from the offset measurement surface point perpendicularly intersects the first reference surface, determining a second point on the second reference surface by determining the point where a second line extending from the offset measurement surface point perpendicularly intersects the second reference surface, and determining the offset distance between the first point and the second point.

In yet another embodiment, a device for determining the offset distance between a first surface and a second surface. The device comprises an imager for obtaining at least one image of the first surface and the second surface, a monitor for displaying the at least one image of the first surface and the second surface, and a central processor unit for determining the three-dimensional coordinates of at least three surface points on the first surface, determining the three-dimensional coordinates of at least three surface points on the second surface, determining a first reference surface based on the three-dimensional coordinates of the at least three surface points on the first surface, determining a second reference surface based on the three-dimensional coordinates of the at least three surface points on the second surface, determining a first point on the first reference surface, determining a second point on the second reference surface, and determining the offset distance between the first point and the second point.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a block diagram of an exemplary video inspection device;

FIG. 2 is an exemplary image obtained by the video inspection device of the inner first and second surfaces of two pipes joined together by a weld;

FIG. 3 is a flow diagram of an exemplary method of determining the offset distance between the first surface and the second surface;

FIG. 4 is the exemplary image of FIG. 2 showing cursors and surface points to determine the three-dimensional coordinates and the reference surfaces of the first surface and the second surface;

FIG. 5 is the exemplary image of FIG. 2 showing the first reference surface and the second reference surface; and

FIG. 6 is a point-cloud view showing the reference surfaces and the offset distance between the two reference surfaces.

### DETAILED DESCRIPTION OF THE INVENTION

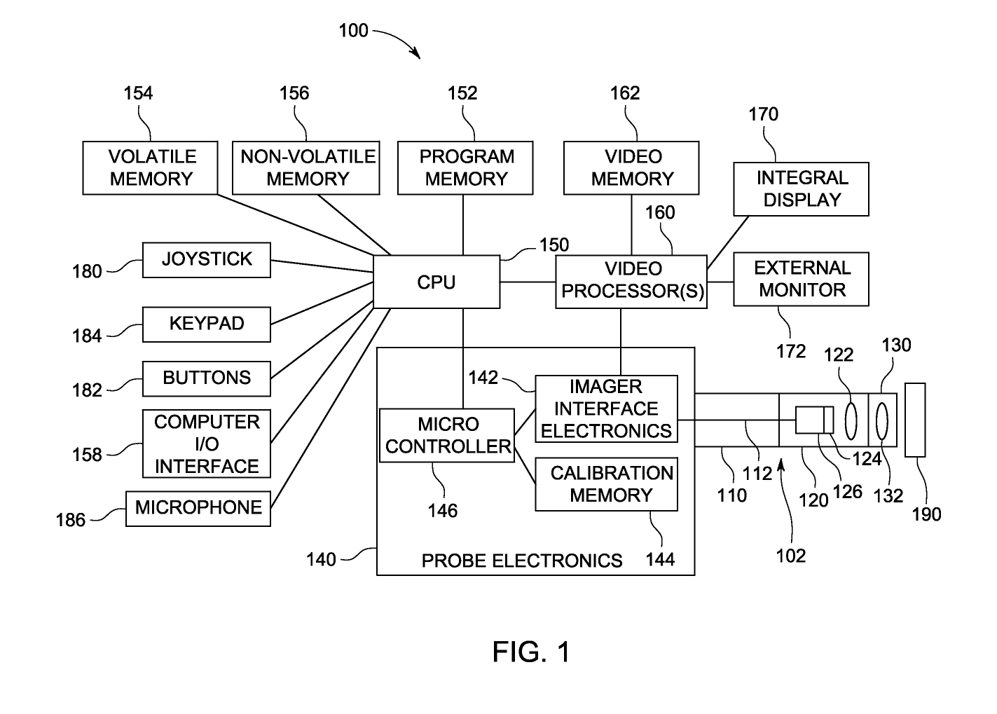

FIG. 1 is a block diagram of an exemplary video inspection device 100. It will be understood that the video inspection device 100 shown in FIG. 1 is exemplary and that the scope of the invention is not limited to any particular video inspection device 100 or any particular configuration of components within a video inspection device 100.

Video inspection device 100 can include an elongated probe 102 comprising an insertion tube 110 and a head assembly 120 disposed at the distal end of the insertion tube 110. Insertion tube 110 can be a flexible, tubular section through which all interconnects between the head assembly 120 and probe electronics 140 are passed. Head assembly 120 can include probe optics 122 for guiding and focusing light from the viewed object 190 onto an imager 124. The probe optics 122 can comprise, e.g., a lens singlet or a lens having multiple components. The imager 124 can be a solid state CCD or CMOS image sensor for obtaining an image of the viewed object 190.

A detachable tip or adaptor 130 can be placed on the distal end of the head assembly 120. The detachable tip 130 can include tip viewing optics 132 (e.g., lenses, windows, or apertures) that work in conjunction with the probe optics 122 to guide and focus light from the viewed object 190 onto an imager 124. The detachable tip 130 can also include illumination LEDs (not shown) if the source of light for the video inspection device 100 emanates from the tip 130 or a light passing element (not shown) for passing light from the probe 102 to the viewed object 190. The tip 130 can also provide the ability for side viewing by including a waveguide (e.g., a prism) to turn the camera view and light output to the side. The tip 130 may also provide stereoscopic optics or structured-light projecting elements for use in determining three-dimensional data of the viewed surface. The elements that can be included in the tip 130 can also be included in the probe 102 itself.

The imager 124 can include a plurality of pixels formed in a plurality of rows and columns and can generate image signals in the form of analog voltages representative of light incident on each pixel of the imager 124. The image signals can be propagated through imager hybrid 126, which provides electronics for signal buffering and conditioning, to an imager harness 112, which provides wires for control and video signals between the imager hybrid 126 and the imager interface electronics 142. The imager interface electronics 142 can include power supplies, a timing generator for generating imager clock signals, an analog front end for digitizing the imager video output signal, and a digital signal processor for processing the digitized imager video data into a more useful video format.

The imager interface electronics 142 are part of the probe electronics 140, which provide a collection of functions for operating the video inspection device 10. The probe electronics 140 can also include a calibration memory 144, which stores the calibration data for the probe 102 and/or tip 130. The microcontroller 146 can also be included in the probe electronics 140 for communicating with the imager interface electronics 142 to determine and set gain and exposure settings, storing and reading calibration data from the calibration memory 144, controlling the light delivered to the viewed object 190, and communicating with the a central processor unit (CPU 150) of the video inspection device 10.

In addition to communicating with the microcontroller 146, the imager interface electronics 142 can also communicate with one or more video processors 160. The video processor 160 can receive a video signal from the imager interface electronics 142 and output signals to various monitors 170, 172, including an integral display 170 or an external monitor 172. The integral display 170 can be an LCD screen built into the video inspection device 100 for displaying various images or data (e.g., the image of the viewed object 190, menus, cursors, measurement results) to an inspector. The external monitor 172 can be a video monitor or computer-type monitor connected to the video inspection device 100 for displaying various images or data.

The video processor 160 can provide/receive commands, status information, streaming video, still video images, and graphical overlays to/from the CPU 150 and may be comprised of FPGAs, DSPs, or other processing elements which provide functions such as image capture, image enhancement, graphical overlay merging, distortion correction, frame averaging, scaling, digital zooming, overlaying, merging, flipping, motion detection, and video format conversion and compression.

The CPU 150 can be used to manage the user interface by receiving input via a joystick 180, buttons 182, keypad 184, and/or microphone 186, in addition to providing a host of other functions, including image, video, and audio storage and recall functions, system control, and measurement processing. The joystick 180 can be manipulated by the operator to perform such operations as menu selection, cursor movement, slider adjustment, and articulation control of the probe 102, and may include a push-button function. The buttons 182 and/or keypad 184 also can be used for menu selection and providing user commands to the CPU 150 (e.g., freezing or saving a still image). The microphone 186 can be used by the inspector to provide voice instructions to freeze or save a still image.

The video processor 160 can also communicate with video memory 162, which is used by the video processor 160 for frame buffering and temporary holding of data during processing. The CPU 150 can also communicate with CPU program memory 152 for storage of programs executed by the CPU 150. In addition, the CPU 150 can be in communication with volatile memory 154 (e.g., RAM), and non-volatile memory 156 (e.g., flash memory device, a hard drive, a DVD, or an EPROM memory device). The non-volatile memory 156 is the primary storage for streaming video and still images.

The CPU 150 can also be in communication with a computer I/O interface 158, which provides various interfaces to peripheral devices and networks, such as USB, Firewire, Ethernet, audio I/O, and wireless transceivers. This computer I/O interface 158 can be used to save, recall, transmit, and/or receive still images, streaming video, or audio. For example, a USB “thumb drive” or CompactFlash memory card can be plugged into computer I/O interface 158. In addition, the video inspection device 100 can be configured to send frames of image data or streaming video data to an external computer or server. The video inspection device 100 can incorporate a TCP/IP communication protocol suite and can be incorporated in a wide area network including a plurality of local and remote computers, each of the computers also incorporating a TCP/IP communication protocol suite. With incorporation of TCP/IP protocol suite, the video inspection device 100 incorporates several transport layer protocols including TCP and UDP and several different layer protocols including HTTP and FTP.

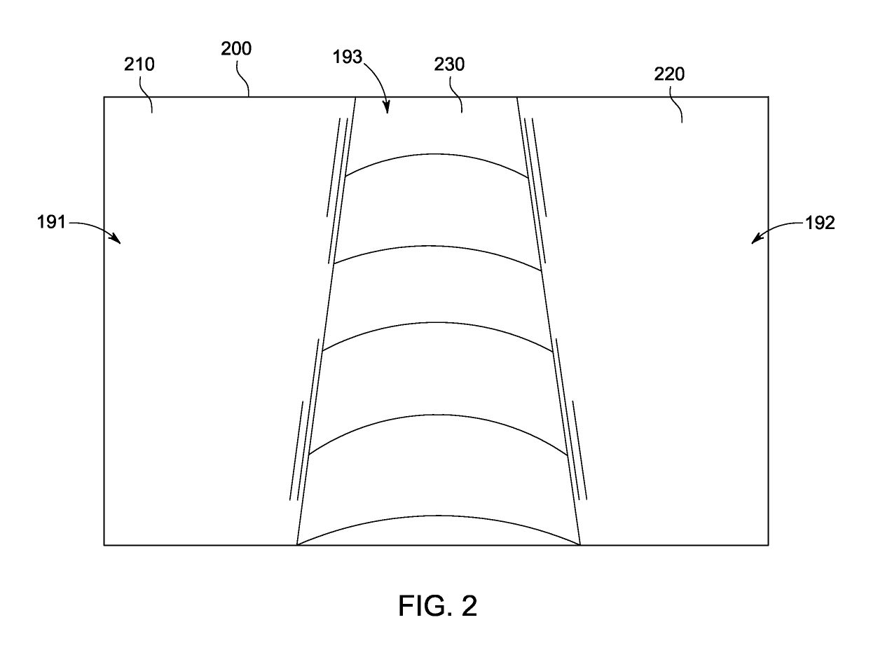

FIG. 2 is an exemplary image 200 obtained by the video inspection device 100 of the inner first and second surfaces 210, 220 of a first pipe 191 and a second pipe 192 joined together by a weld 193. Although the exemplary embodiment will be described with respect to determining the offset distance between the inner surfaces of two pipes, it will be understood that the inventive method can be applied to any surfaces of any objects. As seen in FIG. 2, the inner surface 230 of the weld 193 is raised relative to the first surface 210 and the second surface 220. In the exemplary embodiment, the video inspection device 100 is used to determine the offset distance between the first surface 210 and the second surface 220.

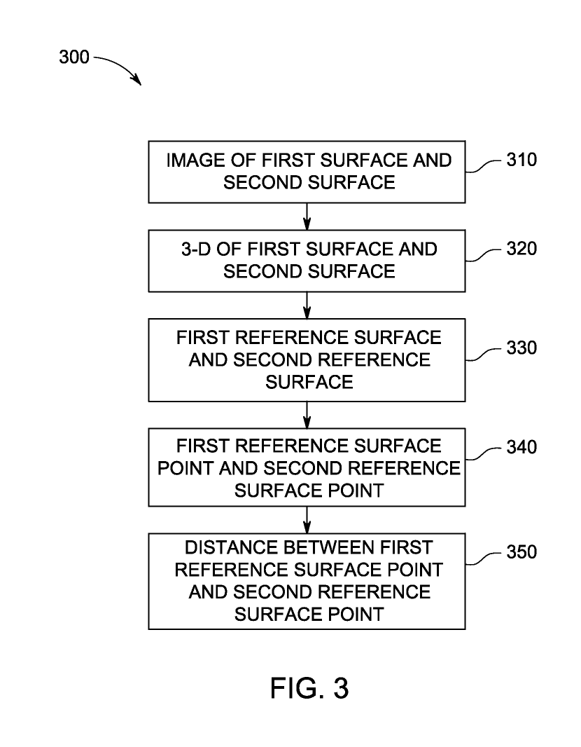

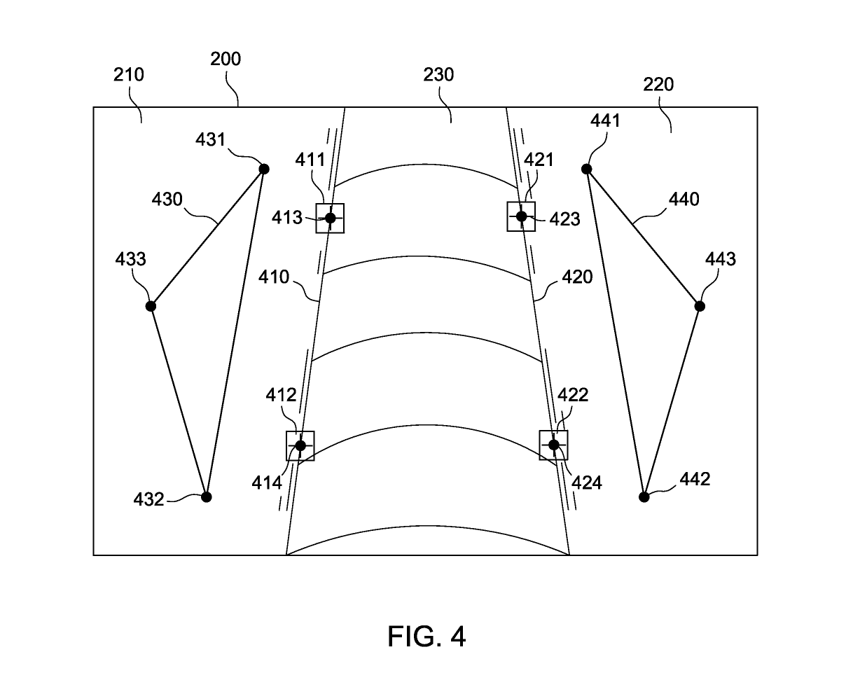

FIG. 3 is a flow diagram of an exemplary method 300 of determining the offset distance between the first surface 210 and the second surface 220 shown in FIG. 2 using a video inspection device 100. The steps described in the flow diagram of FIG. 3 are further illustrated in FIGS. 4, 5, and 6. It will be understood that the steps described in the flow diagram of FIG. 3 can be performed in a different order than shown in the flow diagram and that not all of the steps are required for certain embodiments.

At step 310 of the exemplary method (FIG. 3) and as shown in FIG. 2, the operator can use the video inspection device 100 to obtain at least one image 200 of the first surface 210 and the second surface 220 and display it on a video monitor (e.g., an integral display 170 or external monitor 172). For example, the video inspection device 100 can be used with a crawler delivery system to travel though the interior of the first pipe 191 and the second pipe 192 after the weld 193 is formed.

At step 320 of the exemplary method (FIG. 3) and as shown in FIG. 4, the video inspection device 100 can determine the three-dimensional coordinates (e.g., (x, y, z)) of a plurality of surface points on the first surface 210 and the second surface 220. In one embodiment, the video inspection device can generate three-dimensional data from the image 200 in order to determine the three-dimensional coordinates. Several different existing techniques can be used to provide the three-dimensional coordinates of the surface points in the image 200 of the first surface 210 and the second surface 220 (e.g., stereo, scanning systems, stereo triangulation, structured light methods such as phase shift analysis, phase shift moire, laser dot projection, etc.).

Most such techniques comprise the use of calibration data, which, among other things, includes optical characteristic data that is used to reduce errors in the three-dimensional coordinates that would otherwise be induced by optical distortions. With some techniques, the three-dimensional coordinates may be determined using one or more images captured in close time proximity that may include projected patterns and the like. It is to be understood that references to three-dimensional coordinates determined using image 200 may also comprise three-dimensional coordinates determined using one or a plurality of images 200 of the first surface 210 and the second surface 220 captured in close time proximity, and that the image 200 displayed to the user during the described operations may or may not actually be used in the determination of the three-dimensional coordinates.

In one embodiment and as shown in FIG. 4, after the video inspection device 100 has determined the three-dimensional coordinates of the surfaces shown in the image, the operator can delineate the edges of the first surface 210 and the second surface 220. For example, to delineate the edge of the first surface 210, the operator can place a first edge cursor 411 at a first surface edge point 413 of the first surface 210 and then place a second edge cursor 412 at a second surface edge point 414 of the first surface 210. The video inspection device 100 can determine a first surface edge line 410 of the first surface 210 extending along the axis between the first surface edge point 412 and the second surface edge point 414, identifying all surface points to one side (e.g., the left) of that first surface edge line 410 as the first surface 210. Similarly, to delineate the edge of the second surface 220, the operator can place a first edge cursor 421 at a first surface edge point 423 of the second surface 220 and then place a second edge cursor 422 at a second surface edge point 424 of the second surface 220. The video inspection device 100 can determine a second surface edge line 420 of the second surface 220 extending along the axis between the first surface edge point 422 and the second surface edge point 424, identifying all surface points to one side (e.g., the right) of that second surface edge line 420 as the second surface 220.

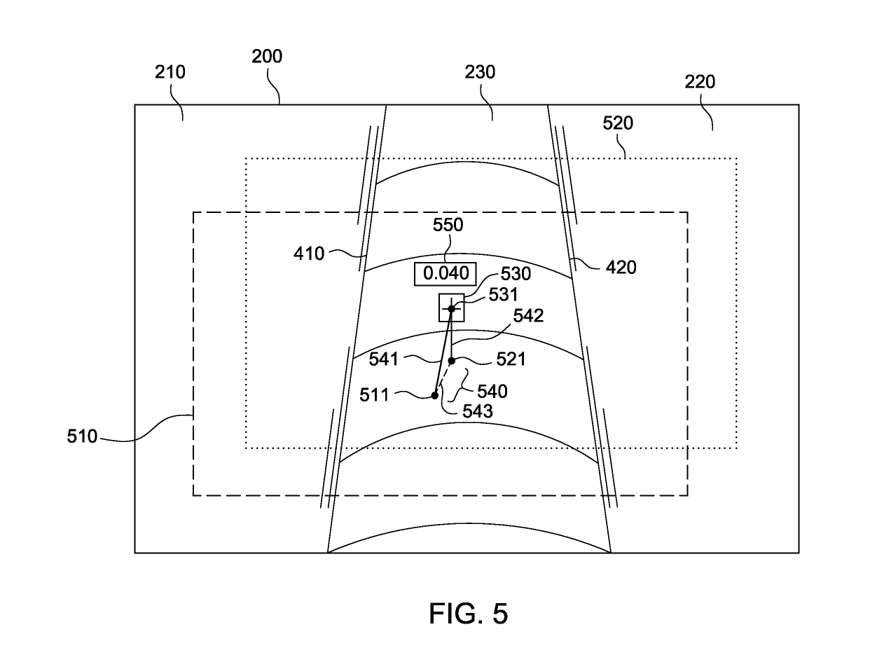

At step 330 of the exemplary method (FIG. 3) and as shown in FIGS. 4 and 5, the video inspection device 100 determines a first reference surface 510, which is based on the three-dimensional coordinates of the first surface 210, and a second reference surface 520, which is based on the three-dimensional coordinates of the second surface 510. In some embodiments, the reference surfaces 510, 520 can be flat, while in other embodiments the reference surfaces 510, 520 can be curved. Similarly, the reference surfaces 510, 520 can be in the form of planes, while in other embodiments, the reference surfaces 510, 520 can be in the form of a shape (e.g., cylinder, sphere, etc.).

As shown in FIGS. 4 and 5, the three-dimensional coordinates of at least three surface points 431, 432, 433 on the first surface 210 can be used to determine the first reference surface 510 (e.g., a plane). Similarly, the three-dimensional coordinates of at least three surface points 441, 442, 443 on the second surface 220 can be used to determine the second reference surface 520 (e.g., a plane). In one embodiment and for improved accuracy, the video inspection device 100 can use the three-dimensional coordinates of all of the surface points on the first surface 210 to determine the first reference surface 510, and the three-dimensional coordinates of all of the surface points on the second surface 220 to determine the second reference surface 520. In other embodiments (e.g., when there are areas to the left of the first surface edge line 410 or to the right of the second surface edge line 420 that do not form part of the first or second surfaces 210, 220), an operator can select at least three surface points on each surface 210, 220 to be used for determining the first and second reference surfaces 510, 520. In another embodiment, an operator can place a polygon 430, 440 on each surface 210, 220 to select the at least three surface points within the perimeter of the polygon.

In one embodiment, the video inspection device 100 can perform regression analysis (e.g., curve fitting) of the three-dimensional coordinates for at least three surface points 431, 432, 433 (x_{iS1}, y_{iS1}, z_{iS1}) on the first surface 210 to determine a first reference surface equation for the first reference surface 510 (e.g., for a plane) having the following form:

k_{0RS1}+k_{1RS1}·x_{1RS1}+k_{2RS1}·y_{1RS1}=z_{1RS1} (1)

where (x_{iRS1}, y_{iRS1}, z_{iRS1}) are the three-dimensional coordinates of any point on the first reference surface 510 and k_{0RS1}, k_{1RS1}, and k_{0RS1} are coefficients obtained by a curve fitting of the three-dimensional coordinates for at least three surface points 431, 432, 433 (x_{iS1}, y_{iS1}, z_{iS1}) on the first surface 210.

Similarly, the video inspection device 100 can perform a curve fitting of the three-dimensional coordinates for at least three surface points 441, 442, 443 (x_{iS2}, y_{iS2}, z_{iS2}) on the second surface 220 to determine a second reference surface equation for the second reference surface 520 (e.g., for a plane) having the following form:

k_{0RS2}+k_{1RS2}·x_{1RS2}+k_{2RS2}·y_{iRS2}=z_{iRS2} (2)

where (x_{iRS2}, y_{iRS2}, z_{iRS2}) are the three-dimensional coordinates of any point on the second reference surface 520 and k_{0RS2}, k_{1RS2}, and k_{2RS2} are coefficients obtained by a curve fitting of the three-dimensional coordinates for at least three surface points 441, 442, 443 (x_{iS2}, y_{iS2}, z_{iS2}) on the second surface 220.

It should be noted that the three-dimensional coordinates of at least three surface points (i.e., at least as many points as the number of k coefficients) are used to perform the curve fitting. The curve fitting determines the k coefficients that give the best fit to the points used (e.g., least squares approach). The k coefficients then define the planes or other reference surfaces 510, 520 that approximate the points used. However, if more points are used in the curve fitting than the number of k coefficients, when you insert the x and y coordinates of the points used into the plane equations (1), (2), the z results will generally not exactly match the z coordinates of the surface points due to noise and any deviation from a plane that may actually exist. Thus, for example and with respect to the first surface 210 and the first reference surface 510, x_{iRS1} and y_{iRS1} can be any arbitrary values, and the resulting z_{iRS1} tells you the z of the defined plane at x_{iRS1}, y_{iRS1}. Accordingly, coordinates shown in these equations can be for arbitrary points exactly on the defined surface, not necessarily the points used in the fitting to determine the k coefficients.

As shown in FIG. 5, the first reference surface 510 defined by the first reference surface equation (1) is extrapolated and extends beyond the area of the first surface 210 to all combinations of x and y coordinates, including those found outside of the first surface 210. Likewise, the second reference surface 520 defined by the second reference surface equation (2) is extrapolated and extends beyond the area of the second surface 220, such that the first reference surface 510 overlaps with the second reference surface 520. This allows an offset distance between the two reference surfaces 510, 520 at particular points where the reference surfaces 510, 520 overlap to be determined.

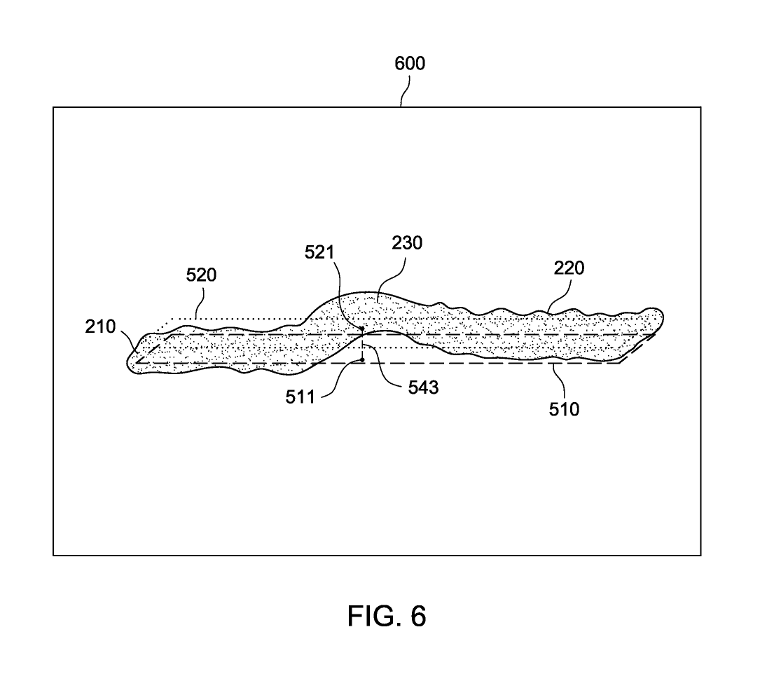

At step 340 of the exemplary method (FIG. 3) and as shown in FIGS. 5 and 6, the video inspection device 100 determines a first reference surface point 511 on the first reference surface 510 and a second reference surface point 521 on the second reference surface 520 that will be used to determine the offset distance 540. As shown in FIGS. 5 and 6, in order to determine the location of the first reference surface point 511 and the second reference surface point 521, the video inspection device 100 must determine a three-dimensional direction of an offset distance line 543 between the two reference surfaces 510, 520 (and the two reference surface points 511, 521). The offset distance 540 is the length of the offset distance line 543. If the first reference surface 510 and the second reference surface 520 are parallel to each other, the three-dimensional direction of the offset distance line 543 is normal (perpendicular) to both reference surfaces 510, 520. But since the first reference surface 510 and the second reference surface 520 are typically not parallel to each other, the three-dimensional direction of the offset distance line 543 may be normal to one or the other reference surface 510, 520, may be in the direction of the minimum distance between the reference surfaces 510, 520, or may be in the direction of the desired offset measurement.

In one embodiment and as shown in FIGS. 5 and 6, the video inspection device 100 determines the location of the first reference surface point 511 and the second reference surface point 521 to be used for determining the offset distance 540 based on the three-dimensional coordinates of an offset measurement surface point 531 on the image 200. This offset measurement surface point 531 can be automatically selected by the video inspection device 100 using, e.g., the midpoint between the first surface edge line 410 and the second surface edge line 420 at the vertical center of the image 200. In another embodiment, the offset measurement surface point 531 can be determined by the operator with an offset measurement cursor 530. The offset measurement surface point 531 can also be determined as an average of several surface points. Once the offset measurement surface point 531 and its three-dimensional coordinates are determined, the video inspection device 100 can determine the first reference surface point 511 as the point where a first surface offset measurement line 541 extending from the offset measurement surface point 531 would perpendicularly intersect the first reference surface 510. Similarly, the video inspection device 100 can determine the second reference surface point 521 as the point where a second surface offset measurement line 542 extending from the offset measurement surface point 531 would perpendicularly intersect the second reference surface 520.

When determining the first reference surface point 511 and the second reference surface point 521 that are perpendicular to the offset measurement surface point 531, the concept of line directions, which convey the relative slopes of lines in the x, y, and z planes, can be used to establish perpendicular lines. For a given line passing through two three-dimensional coordinates (x1, y1, z1) and (x2, y2, z2) (e.g., the offset measurement surface point 531 and the first reference surface point 511 or the second reference surface point 521), the line directions (dx, dy, dz) may be defined as:

dx=x2−x1 (3)

dy=y2−y1 (4)

dz=z2−z1 (5)

Given a point on a line (x1, y1, z1) and the line's directions (dx, dy, dz), the line can be defined by:

$$\frac{( x - x 1 )}{dx} = \frac{( y - y 1 )}{dy} = \frac{( z - z 1 )}{dz} \qquad ( 6 )$$

Thus, given any one of an x, y, or z coordinate, the remaining two can be computed. Two lines having directions (dx1, dy1, dz1) and (dx2, dy2, dz2) are perpendicular if:

dx1·dx2+dy1·dy2+dz1·dz2=0 (7)

The directions for all lines normal to a reference plane defined using equation (1) are given by:

dx_{RSN}=−k_{1RS} (8)

dy_{RSN}=−k_{2RS} (9)

dz_{RSN}=1 (10)

Based on equations (6) and (8) through (10), a line that is perpendicular to the first reference surface 510 or the second reference surface 520 and passing through the offset measurement surface point 531 (x_{OMS}, y_{OMS}, z_{OMS}) can be defined as:

$$\frac{x - {x}_{OMS}}{- {k}_{1 RS}} = \frac{y - {y}_{OMS}}{- {k}_{2 RS}} = z - {z}_{OMS} \qquad ( 11 )$$

where k_{0RS}, k_{1RS}, and k_{2RS} are the coefficients for the first reference surface 510 (k_{0RS1}, k_{1RS1}, and k_{2RS1} determined in equation (1)) or the coefficients for the second reference surface 520 (k_{0RS2}, k_{1RS2}, and k_{2RS2} determined in equation (2)).

As shown in FIGS. 5 and 6, in one embodiment, the three-dimensional coordinates of the first reference surface point 511 (x_{iRS1}, y_{iRS1}, z_{iRS1}) or the coordinates of the second reference surface point 521 (x_{iRS2}, y_{iRS2}, z_{iRS2}) corresponding to the offset measurement surface point 531 (x_{OMS}, y_{OMS}, z_{OMS}) can be determined by defining offset measurement lines 541, 542. The first offset measurement line 541 is normal to the first reference surface 510 (having directions given by equations (8)-(10)) and passes through the offset measurement surface point 531. The second offset measurement line 542 is normal to the second reference surface 520 (having directions given by equations (8)-(10)) and passes through the offset measurement surface point 531. Once the offset measurement lines 541, 542 are determined, the video inspection device can determine the three-dimensional coordinates of the first reference surface point 511 and the second reference surface point 521 where the offset measurement lines 541, 542 perpendicularly intersect the reference surfaces 510, 520. Thus, the coordinates of the first reference surface point 511 (x_{iRS1}, y_{iRS1}, z_{iRS1}) and the coordinates of the second reference surface point 521 (x_{iRS2}, y_{iRS2}, z_{iRS2}) can be determined from equations (1), (2), and (11):

$$\begin{matrix}{z}_{iRS} = \frac{( {k}_{1 RS}^{2} \cdot {z}_{OMS} + {k}_{1 RS} \cdot {x}_{OMS} + {k}_{2 RS}^{2} \cdot {z}_{OMS} + {k}_{2 RS} \cdot {y}_{OMS} + {k}_{ORS} )}{( 1 + {k}_{1 RS}^{2} + {k}_{2 RS}^{2} )} & ( 12 ) \\ {x}_{iRS} = {k}_{1 RS} \cdot ( {z}_{OMS} - {z}_{iRS} ) + {x}_{OMS} & ( 13 ) \\ {y}_{iRS} = {k}_{2 RS} \cdot ( {z}_{OMS} - {z}_{iRS} ) + {y}_{OMS} & ( 14 )\end{matrix}$$

At step 350 of the exemplary method (FIG. 3) and as shown in FIGS. 5 and 6, the video inspection device 100 determines the offset distance 540 between the first reference surface 510 and the second reference surface 520 based on the distance between the first reference surface point 511 and the second reference surface point 521. It will be understood that the offset distance 540 can be equal to this distance between the first reference surface point 511 and the second reference surface point 521 if those are the only reference surface points used. In addition, the offset distance 540 can be determined based on an average of a plurality of offset distances determined for a plurality of pairs of reference surface points on the first and second reference surfaces 510, 520. As shown on FIG. 5, once the offset distance 540 has been determined, the distance can be displayed in the offset distance display 550 on the image 200.

In addition to determining the offset distance 540 between the first reference surface 510 and the second reference surface 520, the video inspection device 100 can also determine and display the angle between the two reference surfaces 510, 520 (or the angle between the first surface offset measurement line 541 and the second surface offset measurement line 542).

As shown in FIG. 6, the video inspection device 100 can provide a rendered three-dimensional view (e.g., a point cloud view) 600 of the surface points of the first surface 210 and the second surface 220, the first and second reference surfaces 510, 520, the first and second reference surface points 511, 521, and the offset distance line 543. This point cloud view 600 shows that the second surface 220 is higher relative to the first surface 210.

In view of the foregoing, embodiments of the invention provide offset distances between surfaces requiring the operator to simply identify the surface edge lines 410, 420, and, in one embodiment, select an offset measurement surface point 531. A technical effect is to provide more accurate offset distance measurements to, e.g., identify improper welds to avoid turbulence, wear, and potentially premature failure of the pipes and the weld.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for determining the offset distance between a first surface and a second surface, the method comprising the steps of:
obtaining and displaying at least one image of the first surface and the second surface;
determining the three-dimensional coordinates of at least three surface points on the first surface;
determining the three-dimensional coordinates of at least three surface points on the second surface;
determining a first reference surface based on the three-dimensional coordinates of the at least three surface points on the first surface;
determining a second reference surface based on the three-dimensional coordinates of the at least three surface points on the second surface;
determining a first point on the first reference surface;
determining a second point on the second reference surface; and
determining the offset distance between the first point and the second point.

2. The method of claim 1, further comprising the step of displaying the offset distance on the image.

3. The method of claim 1, wherein the step of determining the three-dimensional coordinates of at least three surface points on the first surface comprises the steps of:
placing a first cursor on a first edge point of the first surface;
placing a second cursor on a second edge point of the first surface; and
determining an edge line between the first edge point and the second edge point,
wherein the at least three surface points on the first surface are on one side of the edge line.

4. The method of claim 1, wherein the step of determining a first reference surface based on the three-dimensional coordinates of the at least three surface points on the first surface comprises placing at least three cursors on the first surface in the image.

5. The method of claim 1, wherein the step of determining a first reference surface based on the three-dimensional coordinates of the at least three surface points on the first surface comprises placing a polygon on the first surface in the image to select the at least three surface points within the perimeter of the polygon.

6. The method of claim 1, further comprising the step of determining an offset measurement surface point on the at least one image, wherein the offset measurement surface point is used to determine the first point and the second point.

7. The method of claim 6, wherein the offset measurement surface point is determined by placing a cursor on the at least one image.

8. The method of claim 6, wherein the offset measurement surface point is determined automatically.

9. The method of claim 6, wherein the step of determining a first point on the first reference surface comprises determining the point where a first line extending from the offset measurement surface point perpendicularly intersects the first reference surface.

10. The method of claim 6, wherein the step of determining a second point on the second reference surface comprises determining the point where a second line extending from the offset measurement surface point perpendicularly intersects the second reference surface.

11. The method of claim 1, wherein the step of determining the offset distance between the first point and the second point comprises determining an offset distance line between the first point and the second point, wherein the length of the offset distance line is the offset distance.

12. The method of claim 11, further comprising the step of displaying a point cloud view of the first and second reference surfaces, the first and second points, and the offset distance line.

13. The method of claim 1, further comprising the step of determining the angle between the first reference surface and the second reference surface.

14. The method of claim 1, wherein the step of determining the three-dimensional coordinates of at least three surface points on the first surface and the second surface is performed using phase shift analysis.

15. The method of claim 1, wherein the step of determining the three-dimensional coordinates of at least three surface points on the first surface and the second surface is performed using stereo triangulation.

16. The method of claim 1, wherein the first reference surface and the second reference surfaces are planes.

17. The method of claim 1, wherein the step of determining a first reference surface based on the three-dimensional coordinates of the at least three surface points on the first surface comprises regression analysis of the three-dimensional coordinates.

18. The method of claim 1, wherein the first surface and the second surface are joined together by a weld.

19. A method for determining the offset distance between a first surface and a second surface, the method comprising the steps of:
obtaining and displaying at least one image of the first surface and the second surface;
determining the three-dimensional coordinates of at least three surface points on the first surface;
determining the three-dimensional coordinates of at least three surface points on the second surface;
determining a first reference surface based on the three-dimensional coordinates of the at least three surface points on the first surface;
determining a second reference surface based on the three-dimensional coordinates of the at least three surface points on the second surface;
determining an offset measurement surface point on the at least one image;
determining a first point on the first reference surface by determining the point where a first line extending from the offset measurement surface point perpendicularly intersects the first reference surface;
determining a second point on the second reference surface by determining the point where a second line extending from the offset measurement surface point perpendicularly intersects the second reference surface; and
determining the offset distance between the first point and the second point.

20. A device for determining the offset distance between a first surface and a second surface, the device comprising:
an imager for obtaining at least one image of the first surface and the second surface;
a monitor for displaying the at least one image of the first surface and the second surface; and
a central processor unit for
determining the three-dimensional coordinates of at least three surface points on the first surface,
determining the three-dimensional coordinates of at least three surface points on the second surface,
determining a first reference surface based on the three-dimensional coordinates of the at least three surface points on the first surface,
determining a second reference surface based on the three-dimensional coordinates of the at least three surface points on the second surface,
determining a first point on the first reference surface,
determining a second point on the second reference surface, and
determining the offset distance between the first point and the second point.
